(19) United States
(12) Patent Application Publication
(10) Pub. No.: US 2026/0296382 A1
(43) Pub. Date: Oct. 1, 2026

(54) MAGNETICALLY CHARGED CHOCK AND STAND

(71) Applicant: Peter Knight, Ft. Lauderdale, FL (US)

(72) Inventor: Peter Knight, Ft. Lauderdale, FL (US)

(21) Appl. No.: 19/702,727

(22) Filed: Jun. 9, 2026

Related U.S. Application Data
(63) Continuation of application No. 18/152,472, filed on Jan. 10, 2023.

(51) Int. Cl. B60T 3/00; H02J 7/70

(52) U.S. Cl. CPC B60T 3/00; H02J 7/731

(57) ABSTRACT

A chock charging stand provides a framework for retaining an inductive charging plate for charging one or more chocks. Chocks may have light source(s) to emit light during low-light conditions. Chocks may charge using inductance, wired connection, and/or renewable energy production. Chocks may have transmitter-receivers for communicating with a master control and/or smart device.

### FIELD

The present disclosure generally relates to wheel chocks, and more particularly to rechargeable, lighted wheel chocks.

### BACKGROUND

Chocks have enjoyed a long history of use throughout the world. While modern chocks are used commonly in automotive, railroad, and aviation markets, the earliest use of chocks may have been for barrel retention, or casks, as they were often called. Such devices began to be patented by the late 19^{th} century, with patents issuing for vehicle-based wheel chocks in the early 20^{th} century.

Chocks have generally been used as a way to arrest movement of or retain circular objects in place or any objects that have a tendency to move or roll. Chocks are implemented either as a way to protect the object retained, or to protect other objects from the movement of the retained object. Chocks are commonly used in pairs, such that each chock may be placed on either side of a circular object, such as a wheel. However, chocks may only be placed on one side of the object, such as in a parking lot where a chock (e.g., a parking curb) may be placed to arrest the movement of a vehicle at a specified distance from a sidewalk or another vehicle.

The earliest chocks were often formed of wood or other natural materials and often took a wedge-shape or triangular form. However, various materials have been used depending on the use or application of the chock. The chock size also may vary depending on the size of the object it is arresting or retaining. Chocks may be permanently placed or may be removeable. A parking curb may be set in place permanently, whereas a pair of chocks used to prevent movement of an aircraft wheel may be placed and removed regularly, such that weight, visibility, and other factors may be a concern.

Therefore, an improved chock would optimize arrest and retention of objects while improving ease of use, such as improving visibility of the chock at night or in low visibility, reducing tripping hazard or equipment damage from running over the chock and so forth.

### SUMMARY

A chock charging stand comprises a framework, an inductive charging plate coupled to the framework, at least one chock positioned on the inductive charging plate, and a power source electrically coupled to the inductive charging plate, wherein electrical power is converted into magnetic field energy to charge the at least one chock.

A chock comprises a body shaped to retain objects, a compartment coupled to the body, the compartment having, an inductor for converting magnetic field energy into electrical power, a battery for storing the electrical power, and control circuitry for regulating use of the electrical power, and a light source electrically coupled to the control circuitry, wherein the light source emits light away from the chock as directed by the control circuitry.

### BRIEF DESCRIPTION OF THE DRAWINGS

Various aspects and advantages will become apparent upon review of the following detailed description and upon reference to the drawings in which:

FIG. 1 illustrates an isometric view of a chock charging stand;

FIG. 2 illustrates an isometric view of a pair of chocks coupled by a tether;

FIG. 3 illustrates an isometric view of a pair of chocks coupled by a tether and with one of the chocks shown in cross-section;

FIG. 4 illustrates an isometric view of a pair of chocks having an end-mounted compartment coupled by a tether;

FIG. 5 illustrates an isometric view of a chock having opposing end-mounted compartments;

FIG. 6 illustrates a cross-sectional view of a chock positioned over a surface; and

FIG. 7 illustrates a side view of a chock.

### DETAILED DESCRIPTION

The following disclosure describes an improved chock for retaining objects and a system for charging a plurality of chocks. The apparatus includes a chock having light emitting capability, a battery for providing power, and a charging means for charging the battery. The system includes one or more charging stations and a power source for providing power to the one or more charging stations, such as when the apparatus is placed thereon.

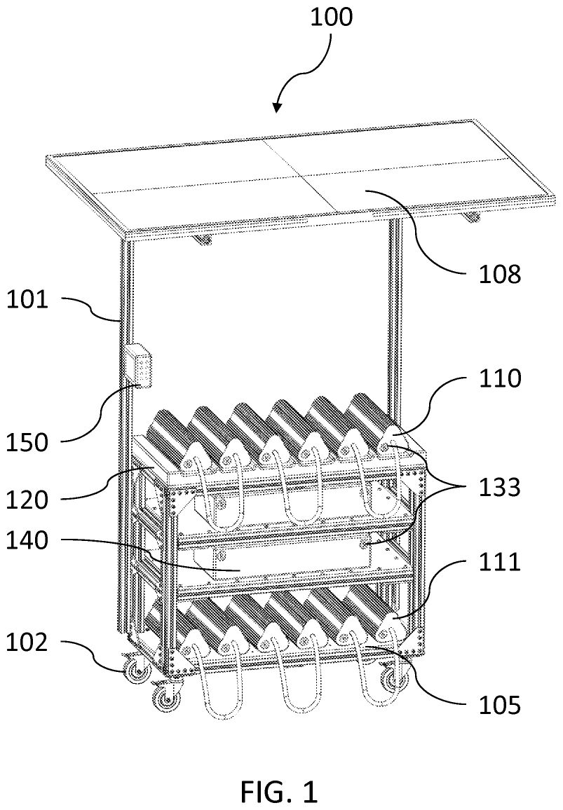

FIG. 1 illustrates a chock charging stand 100. Chock charging stand 100 may include a body or framework formed of one or more frame elements 101. Frame elements 101 may enable attachment of one or more wheels 102, one or more charging plates 120, one or more batteries 140, and a master control 150. Further, one or more chocks and/or one or more pairs of chocks may be placed on charging stand 100 for charging (e.g., pair of chocks 110 may be placed on one or more charging plates 120) and/or for storage (e.g., pair of chocks 111 may be placed on storage shelf 105).

The one or more charging plates 120 may be a single charging plate capable of charging a plurality of chocks and/or pairs of chocks (e.g., FIG. 1 exemplifies a charging plate capable of charging 3 pairs of chocks or a total of 6 chocks, though greater or fewer chocks may be charged simultaneously, e.g., between 1 and 10 chocks per charging plate). The one or more charging plates 120 may be two or more charging plates, wherein the plurality of charging plates may each be capable of charging one or a plurality of chocks and/or pairs of chocks (e.g., storage shelf 105 may be replaced with a second charging plate).

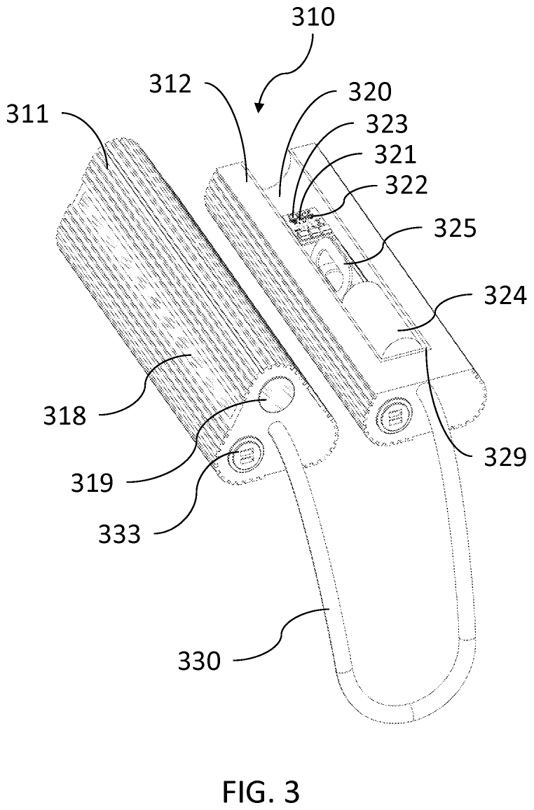

The one or more charging plates 120 may be configured to transfer power from a power source through the one or more charging plates 120 to charging circuitry on and/or within the one or more chocks 110 (e.g., charging circuitry 325 of FIG. 3). The one or more charging plates 120 may receive power from one or more batteries 140. The one or more charging plates 120 may receive power via a standard wall plug when connected to a wall outlet (e.g., a three-pronged socket). The one or more charging plates 120 may receive power from one or more power generating means (e.g., power generated by solar cells 108 mounted to frame elements 101). Power is generally understood to refer to electrical power, such as may be measurable as current, voltage, and/or watts.

Charging of the one or more chocks 110 (e.g., transfer of electrical power to the one or more chocks) may be accomplished by utilizing inductive components in the one or more charging plates 120 and/or within each of the one or more chocks 110. By this method power (e.g., electrical current) may be passed through one or more inductors in the one or more charging plates 120 (e.g., an inductor corresponding to each of the one or more chocks 110) which may produce a magnetic field, a form of stored energy, in the vicinity of each inductor (e.g., at discrete locations along the one or more charging plates 120). Similarly, inductive circuitry within each of the one or more chocks 110 may be excited by the magnetic field, such that the energy of the magnetic field created by each inductor may be converted back into electrical power within each of the one or more chocks 110, respectively. Thus, charging may be accomplished wirelessly, merely by proximity, between the one or more charging plates 120 and the one or more chocks 110.

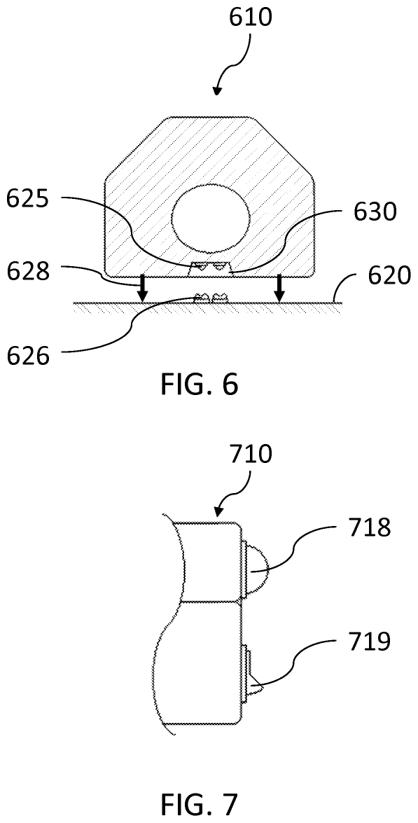

Charging may be accomplished by other means, such as by charging prongs (e.g., as exemplified in FIG. 6), by corded coupling (e.g., via USB), and so forth. Each of the one or more batteries 140 may have one or more auxiliary charging ports 133 (e.g., USB connection terminals), and each of the one or more chocks 110 may have one or more auxiliary charging ports 133 (e.g., USB connection terminals) to enable wired charging.

When used, the one or more batteries 140 may require periodic charging. The one or more batteries 140 may receive power via a standard wall plug when connected to a wall outlet (e.g., alternating current, which may be converted to direct current, such as by a bridge rectifier, to be stored within the battery). The one or more batteries 140 may receive power from one or more power generating means, such as from solar cells 108 mounted to frame elements 101 (e.g., harvesting energy from solar radiation), from wind turbines (e.g., harvesting energy from air flow), or any combination thereof. While chock charging stand 100 is illustrated as having wheels 102 to facilitate mobility, it is conceivable that chock charging stand 100 may be permanently mounted to the ground and may have a hard-wired power source, and may be secure against strong winds (e.g., having 3 walls and a door to prevent loss or theft of the one or more chocks 110).

Master control 150 may include a screen (e.g., a touch screen) and/or buttons to enable a user to monitor the one or more chocks 110. Monitoring may include tracking metrics such as operating condition (e.g., on/off), charging status, charging levels, alert settings, alert status (e.g., low battery indication), geographic positioning information, error status, and other metrics. Master control 150 may have appropriate hardware and software to perform these monitoring functions. Master control 150 may have one or more microcontrollers, GPS receivers, and one or more transmitters/receivers to enable communication (e.g., sending and receiving of data signals) with the one or more chocks 110 (e.g., Wi-Fi, Bluetooth, radio frequency, and/or cellular transmitters/receivers). A remote smart device having these capabilities may further have a software application which enables the user to perform the same monitoring functions, control the chock charging stand 100 remotely, and/or control the one or more chocks 110 remotely (e.g., a software application may be installed on the smart device, represented by a software application icon, which when touched or activated may initiate the software application and allow the user to access and modify various operational parameters associated with the chock charging stand 100 and/or the one or more chocks 110).

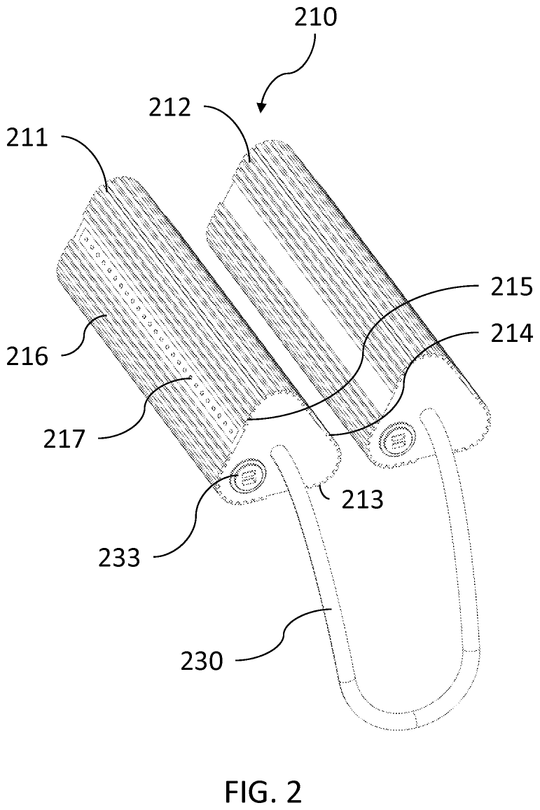

FIG. 2 illustrates a pair of chocks 210 coupled by a tether 230. The pair of chocks 210 may include a first chock 211 and a second chock 212. The first chock 211 and the second chock 212 may be identical, or may each have different features. First chock 211 and second chock 212 may be formed as a three-sided extrusion (e.g., approximately triangularly shaped and extending between opposing ends), though it is conceivable that other symmetric or nonsymmetric shapes may be possible (e.g., as exemplified in FIG. 6).

At least one side may be downward facing to contact the ground (e.g., bottom-side 213). At least one side may be object-facing to contact the object (e.g., a barrel) to be retained (e.g., object-side 214). At least one side may be outward-facing such that it neither contacts the ground nor faces the object to be retained (e.g., outward-facing-side 215). Any remaining sides, including the opposing ends on either side of the extruded shape, may also neither contact the ground nor face the object. The outward-facing-side 215, the opposing ends, and any remaining sides may be available for other useful purposes as presented in this disclosure.

Each of the sides, but particularly the bottom-side 213 and the object-side 214 may have one or more ridges 216. Ridges 216 may increase the surface area of each side and may increase friction and/or traction to prevent slippage of the chock 211 when in use to retain the object (e.g., a wheel of an automobile).

Outward-facing-side 215 may have one or more light sources 217 (e.g., an LED light strip with a plurality of LEDs positioned incrementally along the length of the LED light strip) positioned to emit light away from chock 211. Light emitted by the one or more light sources 217 may enable the chock to be visible at night, during inclement weather, or at other times of low visibility. Further, light emission may prevent chock 211 from being left out or becoming a tripping hazard during the low visibility conditions described in this disclosure. Light sources 217 may be electrically coupled to and powered by circuitry contained within chock 211 as further described in this disclosure.

Any remaining sides, including the opposing ends, which also form physical sides of chock 211, may likewise include one or more light sources to emit light away from chock 211 as taught in this disclosure. Further, the bottom-side 213 and object-side 214 may likewise include one or more light sources since it would be faster and easier to position the chock during use without having to ensure proper orientation of each side (e.g., each side can be any side of the configuration).

Chock 211 may have a USB connection terminal 233 to enable charging of chock 211, or further to enable charging of a secondary device from the power stored in chock 211.

FIG. 3 illustrates a pair of chocks 310 coupled by a tether 330. A first chock 311 is shown in whole and a second chock 312 is shown in part, having a cross-sectional cut with an upper portion of the second chock 312 removed to show the internal circuitry contained within each chock of the pair of chocks 310. Each of the pair of chocks 310 may include a light source (e.g., light emitting diodes, laser diodes, infra-red light sources, or other light sources within or outside the visible spectrum) to emit light away from the chock during use. The light source may be contained within the chock 311, 312 (e.g., within a cavity of the chock) since a protruding light source could be more susceptible to breakage during use of the chock 311, 312.

A cover 318 may be placed over the light source to protect it from impact, moisture, or other contaminants. Further, cover 318 may be formed of a diffusive material to scatter light emitted by the light source and passing through cover 318. The use of diffusive material may increase visibility of the chock 311, 312.

Each of the pair of chocks 310 may be equipped with a switch 319 and/or a pair of chocks 310 may have a single switch 319 for the pair. Switch 319 may be a manual toggle (e.g., as exemplified in FIG. 7), a button, a touch sensitive switch (e.g., an induction switch), and/or may include a light sensitive sensor for detecting low visibility conditions and automatically activating the light source without user interaction. Further, switch 319 may be back-lit so that an operating condition of the chock 311, 312 may be indicated by the back-lighting (e.g., indicated by a flashing pattern, indicated by one of various colors, and/or indicated by a visual display capable of showing letters and/or numbers associated with the operating condition).

Chock 311, 312 may have a USB connection terminal 333 to enable charging of chock 311, 312, or further to enable charging of a secondary device from the power stored in chock 311, 312.

In the cross-section of chock 312, a cavity 320 is formed along a portion of chock 312. Within cavity 320 is a rigid housing 329 formed to be structurally resistant to impact, compression, or other force-related deformation whereas the outer later of chock 311, 312 is formed of rubberized and/or plastic material having a high coefficient of friction, having some flexibility and capable of a degree of deformation. Within housing 329 is contained control circuitry for regulating and/or enabling the various functions of chock 312 and/or the pair of chocks 310. The control circuitry may include one or more microcontrollers 321, a GPS receiver 322, one or more transmitter/receivers 323, a battery 324, and charging circuitry 325.

The one or more microcontrollers 321 may control the flow of power to the other control circuitry in accordance with preprogrammed software, updatable software, or based on physical electrical connections. The one or more microcontrollers 321 may enable various flashing patterns for intermittent light emission from the light source. The one or more microcontrollers 321 may enable various lighting colors of light emission from the light source (e.g., where the light source includes an RGB or RGBW LED).

The one or more microcontrollers 321 may receive GPS coordinates from the GPS receiver 322 and may store them in a memory and/or relay them via transmitter/receiver 323 to a remote master control (e.g., master control 150 of FIG. 1 and/or a smart device). A request for GPS coordinates may be made remotely and transmitted to chock 311, 312, may be received by transmitter/receiver 323, such that GPS coordinates may be retrieved from GPS receiver 322, relayed to transmitter/receiver 323, and transmitted back to the requestor. In this way, the pair of chocks 310 may be located upon request.

A battery 324 may be electrically coupled to the one or more microcontrollers 321 to provide power as needed to the control circuitry. The control circuitry may detect a power level of battery 324 and may periodically relay power level data to the remote master control (e.g., based on increments in time and/or at any time that transmissions are made by transmitter/receiver 323). Further, the one or more microcontrollers 321 may, in response to a low-battery power level, transmit an alert to the remote master control indicating the low-battery status. This alert may enable replacement of the pair of chocks 310 with a more fully charged pair of chocks so that the pair of chocks 310 may be charged (e.g., on chock charging stand 100 of FIG. 1).

Charging circuitry 325 may enable charging of battery 324 when the pair of chocks 310 are placed on a charging plate (e.g., charging plate 120 of FIG. 1). Charging circuitry 325 may include an inductor, charging prongs, and/or USB connection terminals 333. Where charging circuitry 325 includes an inductor, the inductor may be capable of converting energy from a magnetic field into power without regard to which side of the chock 311, 312 is placed on the charging plate. The power may be routed to battery 324 for storage and later use.

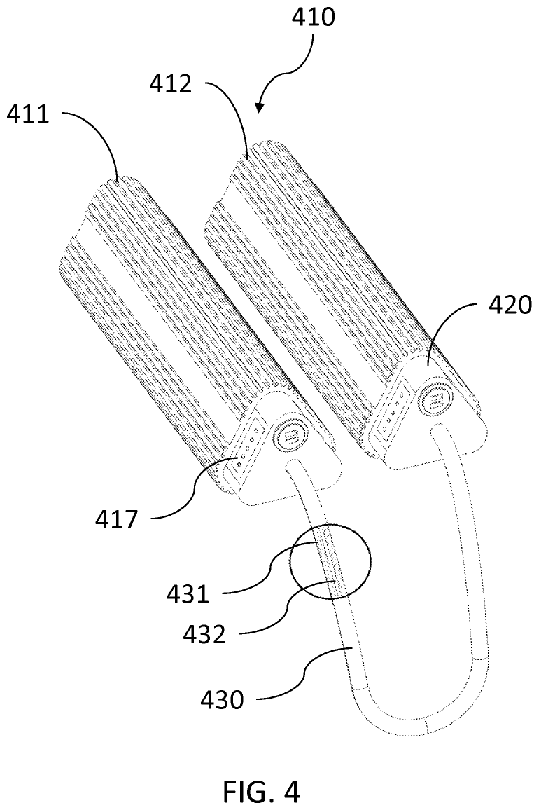

FIG. 4 illustrates a pair of chocks 410 having an end-mounted compartment 420 coupled by a tether 430. Rather than a cavity running through the interior of each chock 411, 412, the charging circuitry, light source(s) 417, battery, and any other circuitry are contained within the end-mounted compartment 420. This configuration is capable of all the features and functions discussed in this disclosure.

While compartment 420 is illustrated on each of chocks 411, 412, it is conceivable that only a single compartment 420 is needed for a pair of tether-bound chocks as represented here. Further, it is conceivable that a single compartment 420 is not coupled to either of chocks 411, 412 but instead is coupled by virtue of the tether 430 extending through compartment 420 or compartment 420 is coupled to tether 430 by some other means.

Tether 430 may serve to couple first chock 411 to second chock 412. Further, tether 430 may serve to electrically couple a first compartment 420 on first chock 411 to a second compartment 420 on second chock 412. Thus, tether 430 may include an exterior sheathing 431 and an inner core 432 as shown in the limited cross-section of a portion of tether 430. Inner core 432 may be electrically conductive wire or other material, and may serve to transfer data signals between the first and second compartments 420 and/or power. Exterior sheathing 431 may be woven or coated nylon or other material to protect inner core 432 and provide strength when lifting chocks 411, 412 by tether 430.

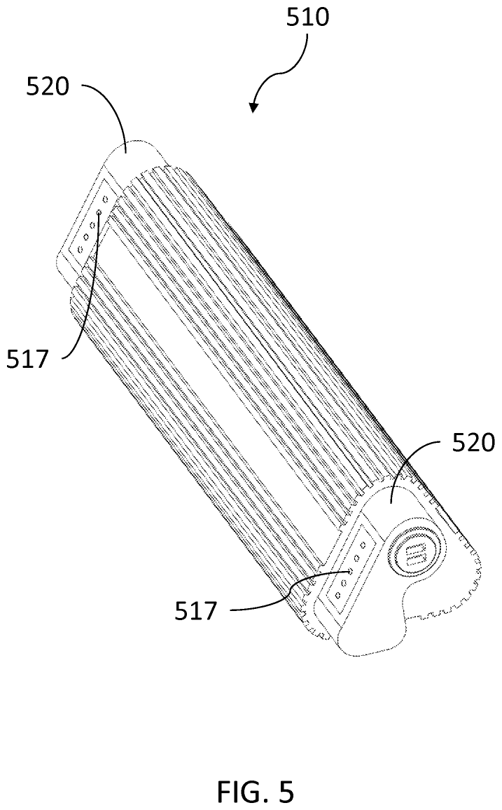

FIG. 5 illustrates a chock 510 having opposing end-mounted compartments 520. The charging circuitry, light source(s) 517, battery, and any other circuitry are contained within the end-mounted compartment 520. This configuration is capable of all the features and functions discussed in this disclosure. In the present configuration the compartments 520 are coupled directly to the chock 510. The chock 510 may be used individually (e.g., as a single chock and not part of a pair). Should a tether be used to pair chock 510 to another chock, the tether would operate independently of compartment 520.

FIG. 6 illustrates a cross-sectional view of a chock 610 positioned over a surface 620. Chock 610 is illustrated as having a polygonal shape (e.g., a curb-shape), though other shaped chocks are contemplated. The charging circuitry, light source(s), battery, and any other circuitry may be contained within the chock 610 and chock 610 may be capable of the features described within this disclosure. Charging prongs 625 may extend from the chock 610 and corresponding charging prongs 626 may extend from the surface 620, such that when chock 610 is moved into contact with surface 620 as indicated by arrows 628, the charging prongs 625, 626 come into contact with each other to enable charging of the chock 610. Charging prongs 625 on the chock 610 may be recessed within cavity 630 to prevent their damage during use of chock 610. While charging prongs require a greater degree of alignment to facilitate charging than induction charging, the concept is presented as an alternative and/or in addition to induction charging.

FIG. 7 illustrates a side view of a curb-shaped chock 710. The charging circuitry, light source(s), battery, and any other circuitry may be contained within the chock 710 and chock 710 may be capable of the features described within this disclosure. Chock 710 may include switch 719 in the form of a manual toggle to turn on and off the features of the chock 710. Chock 710 may include a lens 718 mounted on a side of chock 710 (e.g., one of the opposing ends). Where lens 718 is back-lit, lens may help to distribute light away from chock 710 such that light emission is visible from many directions around chock 710. Further, where chock 710 includes a light sensor, lens 718 may enable improved ambient light input and/or collection to be directed at the light sensor.

Other aspects will be apparent to those skilled in the art from consideration of the specification and practice disclosed herein. It is intended, therefore, that the specification and illustrated embodiments be considered as examples only.

What is claimed is:

1. A chock charging stand, comprising:
a framework;
a control module coupled to the framework, the control module having a transmitter-receiver which communicates wirelessly;
an inductive charging plate coupled to the framework;
at least one chock positioned on the inductive charging plate and having control circuitry that communicates with the control module to receive and request operating conditions; and
a power source electrically coupled to the inductive charging plate and to the control module, wherein electrical power is converted into magnetic field energy to charge the at least one chock.

2. The chock charging stand of claim 1, wherein the at least one chock includes,
a body shaped to retain objects,
a compartment coupled to the body, and
a light source configured to emit light away from the chock.

3. The chock charging stand of claim 2, wherein the compartment includes,
an inductor for converting magnetic field energy into electrical power,
a battery for storing the electrical power, and
the control circuitry regulates use of the electrical power, wherein the light source is electrically coupled to the control circuitry, and wherein the light source emits light as directed by the control circuitry.

4. The chock charging stand of claim 3, wherein the control circuitry includes one or more of a microcontroller, a GPS receiver, and a transmitter-receiver for sending and receiving the operating conditions, charging status, charging levels, alert settings, alert status, low battery indication, geographic positioning information, and error status of the at least one chock.

5. The chock charging stand of claim 3, further including a control module or smart device having a transmitter-receiver which communicates wirelessly with the control circuitry of the at least one chock by requesting and receiving the operating conditions, charging status, charging levels, alert settings, alert status, low battery indication, geographic positioning information, and error status of the at least one chock.

6. The chock charging stand of claim 1, wherein the power source includes one or more of a battery mounted to the framework, an electrical plug capable of connection to a wall socket, a solar cell generating power from sunlight, and a wind turbine generating power from air flow.

7. The chock charging stand of claim 1, wherein the at least one chock includes a pair of chocks connected by a tether.

8. The chock charging stand of claim 1, wherein the at least one chock includes an auxiliary charging port and chock charging stand includes an auxiliary charging port, and wherein electrical power is passed by wired cable from the auxiliary charging port of the chock charging stand to the auxiliary charging port of the at least one chock.

9. A chock, comprising:
a body shaped to retain objects;
a compartment coupled to the body, the compartment having,
an inductor for converting magnetic field energy into electrical power;
a battery for storing the electrical power; and
control circuitry for regulating use of the electrical power and for receiving and requesting operating conditions of the chock; and
a light source electrically coupled to the control circuitry, wherein the light source emits light away from the chock as directed by the control circuitry.

10. The chock of claim 9, wherein the control circuitry includes one or more of a microcontroller, a GPS receiver, and a transmitter-receiver for sending and receiving operating conditions, charging status, charging levels, alert settings, alert status, low battery indication, geographic positioning information, and error status of the chock.

11. The chock of claim 9, wherein the chock includes a pair of chocks connected by a tether.

12. The chock of claim 11, wherein the tether electrically connects the pair of chocks.

13. The chock of claim 10, wherein one or more of the GPS receiver and the transmitter/receiver send and/or receive location data for locating the chock.

14. The chock of claim 9, wherein the compartment is coupled to an exterior of the body.

15. The chock of claim 9, wherein the body includes at least a bottom-side, an object-side, and an outward-facing-side, and wherein the light source is located on the outward-facing-side.

16. The chock of claim 15, wherein the light source includes a plurality of light sources.

17. The chock of claim 16, wherein the plurality of light sources are located on the outward-facing-side and opposing ends of the chock.

18. The chock of claim 9, wherein the chock includes a switch for operating the chock between on and off operating conditions.

19. The chock of claim 18, wherein the switch is a light sensitive sensor that operates the chock based on ambient light input.

20. The chock of claim 18, wherein the switch is a manual toggle for switching operation of the chock.
